(19) United States
(12) Patent Application Publication
(10) Pub. No.: US 2023/0236863 A1
(43) Pub. Date: Jul. 27, 2023

(54) COMMON VOLUME REPRESENTATION IN A CLOUD COMPUTING SYSTEM

(71) Applicant: VMware, Inc., Palo Alto, CA (US)

(72) Inventors: Peng DAI, Acton, MA (US); Matthew B. AMDUR, Winchester, MA (US); Tao XIE, Shanghai (CN); Ruiling DOU, Shanghai (CN)

(21) Appl. No.: 17/678,551

(22) Filed: Feb. 23, 2022

(30) Foreign Application Priority Data
Jan. 21, 2022 (WO) PCT/CN2022/073251

(51) Int. Cl. G06F 9/455

(52) U.S. Cl. CPC G06F 9/45558; G06F 2009/45583; G06F 2009/45595; G06F 2009/4557

(57) ABSTRACT

An example method of providing a common volume (cVol) datastore for virtual machines (VMs) managed by a hypervisor in a cloud computing system includes: mounting, by the hypervisor in cooperation with a network file system server, a network file system share of a common volume (cVol), the network file system share storing metadata for the VMs; creating a file system container backed by the network file system share; routing file operations targeting the metadata to the file system container; attaching cloud volumes as devices on a host of the hypervisor, the cloud volumes referenced by descriptors in the metadata; and routing file operations targeting virtual disks of the VMs to the devices.

### CROSS-REFERENCE

This application is based upon and claims the benefit of priority from International Patent Application No. PCT/CN2022/073251, filed on Jan. 21, 2022, the entire contents of which are incorporated herein by reference.

### BACKGROUND

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

In a virtualized computing system, VMs can interact with a storage subsystem through portable operating system interface (POSIX) file systems. POSIX file systems, however, lack the critical support for policy-based management at the granularity of a virtual disk. Object datastores can use a separate object for each set of VM configuration files, which leads to an inefficient, less scalable, and more complex solution in some environments. It is therefore desirable to provide an improved datastore implementation that overcomes these disadvantages.

### BRIEF DESCRIPTION OF THE DRAWINGS

FIG. 1 is a block diagram of a virtualized computing system in which embodiments described herein may be implemented.

FIG. 2 is a block diagram depicting cVol architecture according to an embodiment.

FIG. 3 is a flow diagram depicting a method of mapping an NFS share of a cVol to the file system of a cVol datastore according to an embodiment.

FIG. 4 is a flow diagram depicting a method of accessing VM metadata of a cVol according to an embodiment.

FIG. 5 is a block diagram depicting a cloud computing system according to embodiments.

FIG. 6 is a block diagram depicting a cVol architecture implemented in a cloud computing system according to embodiments.

FIG. 7 is a flow diagram depicting a method of opening a virtual disk on a cVol according to an embodiment.

### DETAILED DESCRIPTION

Techniques for common volume representation in a virtualized computing system are described. In embodiments, a common volume (cVol) uses a network file system for virtual machine (VM) metadata and an object storage system for virtual disks. With the separation of metadata and data, cVol allows each to be scaled independently. The metadata file system seamlessly enables virtualization management workflows by fulfilling the datastore abstraction while the object storage system offers direct, scalable, and performant access to virtual disks under policy-based management. Compared to existing implementations, cVol eliminates shared storage requirements, increases cluster scalability by stretching the datastore across a greater number of hosts, and improves cost efficiency through namespace sharing. A common volume supports a variety of object storage systems in different endpoints, including native block storage in a cloud data center or federated storage in an on-premises data center, resulting in a unified system architecture and consistent user experience. These and further aspects of the techniques are described below with respect to the drawings.

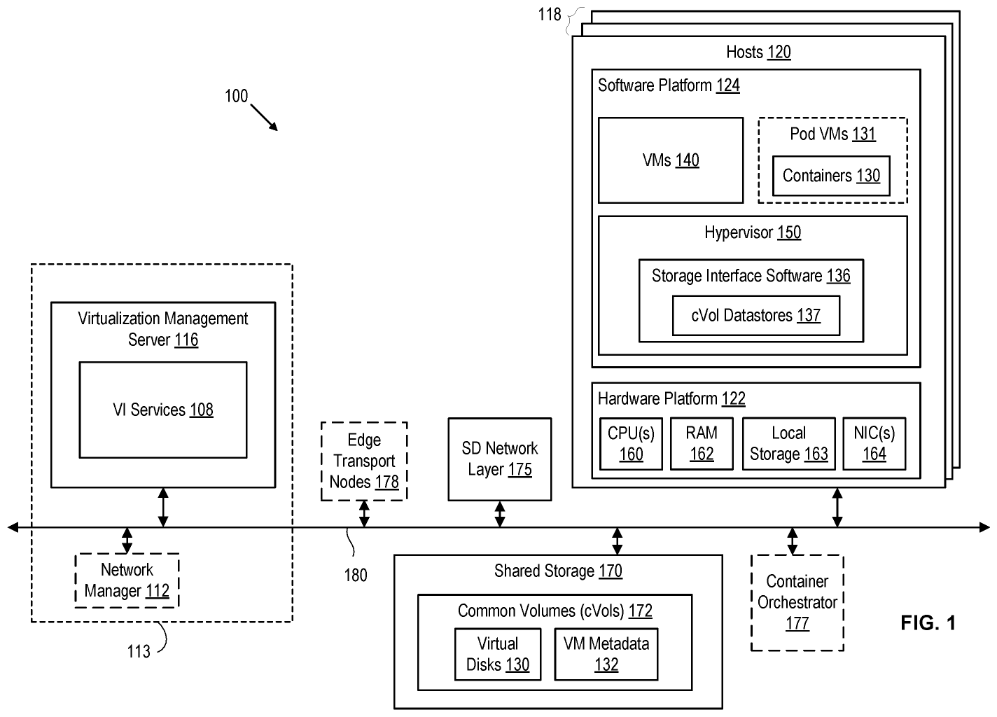

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein. While one physical network 180 is shown, in embodiments, virtualized computing system 100 can include multiple physical networks that are separate from each other (e.g., a separate physical network for storage).

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks (SSDs), flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170. Virtualization management server 116 can select which local storage devices in hosts 120 are part of a vSAN for host cluster 118.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif.

In embodiments, host cluster 418 is configured with a software-defined (SD) network layer 175. SD network layer 175 includes logical network services executing on virtualized infrastructure in host cluster 18. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc.). Edge transport nodes 178 can include a gateway between the internal logical networking of host cluster 148 and the external network. Edge transport nodes 178 can be physical servers or VMs.

In embodiments, virtualization management server 116 is a physical or virtual server that manages host cluster 118 and the virtualization layer therein. Virtualization management server 116 can be deployed as VM(s) 140, containers (e.g., pod VM(s) 131 discussed below), or a combination thereof. Virtualization management server 116 installs agent(s) in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs, containers, or a combination thereof. Network manager 112 installs additional agents in hypervisor 150 to add a host 120 as a managed entity, referred to as a transport node. In this manner, host cluster 118 can be a cluster of transport nodes. One example of an SD networking platform that can be configured and used in embodiments described herein as network manager 112 and SD network layer 175 is a VMware NSX® platform made commercially available by VMware, Inc. of Palo Alto, Calif.

Virtualization management server 116 and network manager 112 comprise a virtual infrastructure (VI) control plane 113 of virtualized computing system 100. In embodiments, network manager 112 is omitted and virtualization management server 116 handles virtual networking. Virtualization management server 116 can include VI services 108. VI services 108 include various virtualization management services, such as a distributed resource scheduler (DRS), high-availability (HA) service, single sign-on (SSO) service, virtualization management daemon, vSAN service, and the like. A VI admin can interact with virtualization management server 116 through a VM management client. Through a VM management client, a VI admin commands virtualization management server 116 to form host cluster 118, configure resource pools, resource allocation policies, and other cluster-level functions, configure storage and networking, and the like.

In embodiments, workloads can also execute in containers 129. In embodiments, hypervisor 150 can support containers 129 executing directly thereon. In other embodiments, containers 129 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150. In embodiments, virtualized computing system 100 can include a container orchestrator 177. Container orchestrator 177 implements an orchestration control plane, such as Kubernetes®, to deploy and manage applications or services thereof in pods on hosts 120 using containers 129. Container orchestrator 177 can include one or more master servers configured to command and configure controllers in hypervisors 150. Master server(s) can be physical computers attached to network 180 or implemented by VMs 140/131 in a host cluster 118.

VMs 131/140 and hypervisor 150 consume and interact with shared storage 170 through a datastore abstraction. In embodiments, shared storage 170 stores common volumes (cVols) 172, which are instantiated on hosts 120 by storage interface software 136 as cVol datastores 137. VI services 108 in virtualization management server 116 can discover cVol datastores 137 as managed objects through host synchronization. In general, hypervisor 150 can support multiple types of datastores, such as virtual machine file system (VMFS) datastores, network file system (NFS) datastores, vSAN data stores, virtual volume (vVol) datastores, and cVol datastores 137. Each datastore offers durable and strongly consistent metadata and data access Other than those common denominators, the datastores offer varying properties in terms of availability, policy, performance, and storage protocols used to access the data. Regardless of the type and implementation details, the datastore abstraction serves the following functionalities.

A datastore provides a VM catalog that supports create, update, and delete (CRUD) operations over a file system interface (e.g., a POSIX or POSIX-like interface) for VMs 131/140. A datastore provides a namespace for each VM that resides on the datastore either completely or partially (e.g., some virtual disks). The VM namespace serves as a container of VI metadata, such as virtual machine configuration files (e.g., vmx files), log files, disk descriptors, and the like. VM metadata are stored in files accessible through the file system interface. A datastore provides virtual disks for each VM either directly or indirectly. A datastore provides storage for infrastructure metadata that may be related to VMs but are not specific to any VM. A datastore provides locking to arbitrate access across multiple concurrent consumers. In some embodiments, a datastore can be used without a VM/container to store virtual disks (e g., sometimes referred to as first class disks).

Some datastores, such as VMFS and NFS datastores, are backed by POSIX file systems. A VMFS datastore, for example, uses a cluster file system. An NTS datastore, for example, uses an industry standard NFS protocol head over local file systems. The datastore functionalities map directly to the POSIX semantics of the backing file systems. Specifically, each VM namespace is backed by a regular directory. The Ni catalog is supported through a directory listing. Virtual disks are backed by regular files. Access arbitration is implemented using file locking. A disadvantage of these types of datastores is the lack of support for policy-based management at the granularity of a virtual disk. Policy serves as a contract between application and storage system. A contract defined in terms of application intent at the granularity of a virtual disk (e.g., the scope of storage consumption) can be critical to ensure the consistency of application behavior. The lack thereof obfuscates the application/storage interface, which makes it difficult to determine application behavior and to size the application. This is determined by the file-based implementation of virtual disks as files, which inherit the properties of the file system as a whole.

Object datastores, such as vSAN and vVol aim to address the gap of file system-based datastores with object support. In an object datastore, virtual disks are backed by objects, the behavior of which can be individually controlled via defined policies. Unlike file-based datastores, an object datastore can be backed by a file system, such as the Object Store File System (OSFS), OSFS is a virtual file system that maps POSIX operations to the underlying storage systems. Specifically, each VM namespace is backed by its own POSIX file system. In the case of vSAN and block-based vVol, the datastores can use VMFS (for example) on top of an individual object. In the case of NFS-based vVol, datastores can use an individual NFS share. VM metadata access and arbitration map to the POSIX semantics of the VM namespace file system. The VM catalog is implemented as a virtual directory with its content backed by storage systems and obtained by the host via out-of-band mechanisms, such as the cluster management, monitoring, and directory service (CMMDS) for vSAN and vStorage application programming interfaces (APIs) for Storage Awareness (VASA) for vVol. Virtual disks are backed by individual objects that are access through pointers (or descriptors) stored in regular files in the VM namespace file system.

Each cVol 172 also implements a datastore abstraction and stores virtual disks 130 and VM metadata 132. As described further below, each cVol 172 uses a network file system to host the namespaces of all VMs 140 as regular directories. Virtual disks 130, however, are backed by individual objects that are stored in a separate object storage pool and accessed via descriptors stored in the VM namespace. The lifecycle, access, and data services of an object are managed through an object storage control plane, the implementation of which is specific to the object storage pool in use (e.g., vSAN, vVol, or the like).

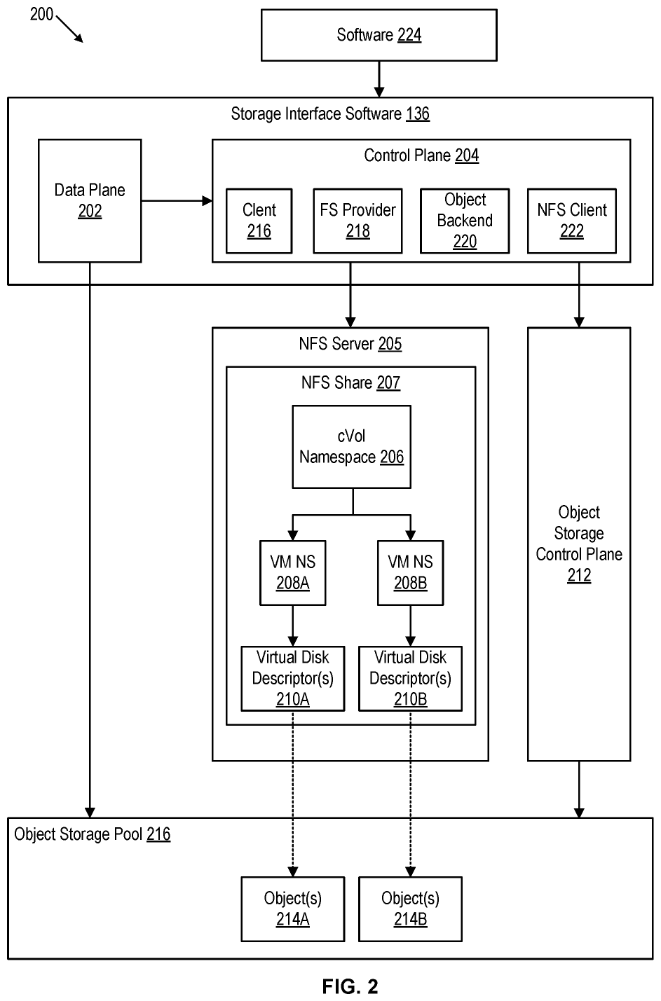

FIG. 2 is a block diagram depicting cVol architecture 200 according to an embodiment, cVol datastore 137 in hypervisor 150 includes a data plane 202 and a control plane 204. Software 224 (e.g., executing in a VM 131/140) accesses a cVol 172 through cVol datastore 137 of storage interface software 136. Data plane 202 is configured to access virtual disks stored as objects in an object storage pool 217. Data plane 202 writes data to, and reads data from, the virtual disks on behalf of VMs 140. Control plane 204 is configured to manage VM namespaces, object policies, and the like. In embodiments, control plane 204 includes an object storage control client 216, a file system (FS) provider 218, object backend 220, and an NFS client 222. Object storage control client 216 interacts with control plane 204 for object lifecycle management. Object backend 220 plugs into the object abstraction in storage interface software 136. Storage interface software 136 can include other components, such as a file system daemon (FSD) and file system driver. The FSD can be an OSFS daemon (osfsd), for example, and is configured to receive operations from software 224, such as lookup and read directory operations, as well as CRUD operations for VM nan respaces. The FSD performs the operations through system calls to the FS driver through FS provider 218. Data plane 202 relies on control plane 204 for locking.

The FS driver (e g., an OSFS driver) implements cVol datastore 137 as a file system (e.g., OSES) referred to as an FS container (e.g., OSFS container) having the type cVol (“cVol FS container”). The cVol FS container is backed by an NFS share 207 managed by an NFS server 205. NFS share 207 stores VM metadata 132 of a cVol 17. FS provider 218 is configured to manage the mapping between a cVol datastore 137 and NFS share 207. FS provider 218 routes file system requests targeting cVol datastore 137 to NFS server 205 through NFS client 222. In embodiments, NFS share 207 is invisible to software 224. NFS server 205 can be a physical server or a VM.

Each cVol 172 stores VM metadata in a cVol namespace 206 on NFS share 207, which includes separate VM namespaces for each VM 140 (e.g., VM namespace (NS) 208A and VM NS 208B for two different VMs 140). Each VM NS 208A and 208B is a separate directory in NFS share 207 and includes files for storing VM metadata 132. NTS share 207 can include a separate directory (not shown) for storing infrastructure metadata (if present). NFS share 207 does not store virtual disks 130 for VMs 140. Rather, virtual disks 130 are backed by objects in object storage pool 217. Each VM namespace includes virtual disk descriptors that include information for identifying objects in object storage pool that back virtual disks 130 (e.g., virtual disk descriptors 210A in VM NS 208A and virtual disk descriptors 210B in VM NS 208B). Virtual disk descriptors 210A point to objects 214A in object storage pool 217 (e.g., virtual disks for the VM in VM NS 208A). Virtual disk descriptors 210B point to objects 214B in object storage pool 217 (e.g., virtual disks for the VM in VM NS 208B). As such, virtual disks 130 are stored and managed as objects in object storage pool 217.

Control plane 204 manages virtual disks through an object storage control plane 212. Object storage control plane 212 performs CRUD operations for objects in object storage pool 217.

The network tile system used to store VM metadata should not be confused with the NFS protocol. As long as it offers POSIX semantics and meets the consistency, availability, and scalability requirements, any network file system implementation can be used, including NFS.

Compared to file-based datastores and object datastores, cVols offer a number of unique benefits. Object datastores use a separate file system for each VM namespace. A cVol is more efficient and scalable. Specifically, a VM namespace typically has a small storage footprint in terms of capacity and input/output operations per second (IOPS) usage. Object datastores typically over-provision storage for each VM namespace to avoid running out of resources. For example, a VM namespace on a vSAN datastore can have a 256 GB nominal capacity. When thin provisioning is not an option, such as in a cloud, the provisioned size of VM namespaces can lead to significant cost inflation. A cVol provides a single NFS share that stores each VM namespace, which can be more efficiently provisioned and scaled depending on the number of VM namespaces. For cVols, the VM catalog is implemented as a directory listing over NFS without the need for a separate out-of-band mechanism. Further, VM namespace sharing in a cVol reduces the number of objects and/or protocol endpoints needed, leading to a more scalable solution.

Compared to object datastores that use a file system (e.g., VMFS) for VM namespaces, cVol is more scalable and portable. Specifically, as a symmetric clustered file system, the size of a VMFS cluster (e.g., the number of hosts that can concurrently mount the same file system) is limited to a certain number of hosts (e.g., 64 hosts). Due to architectural differences, NFS is not subject to the same scalability limit. With proper sizing of the NFS share for mostly VM metadata workload, a cVol datastore backed by NFS can be mounted across a larger number of hosts and clusters for increased reach. Moreover, VMFS imposes shared storage requirements that are not always met. By eliminating these requirements, NFS lowers the barrier of entry, reduces overall complexity, and increases portability across different environments.

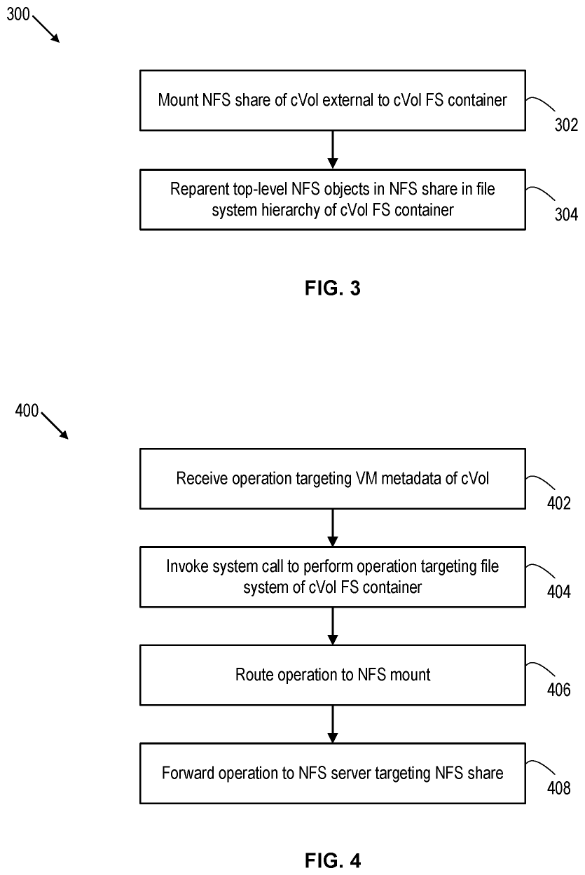

FIG. 3 is a flow diagram depicting a method 300 of mapping an NFS share of a cVol to the file system of a cVol datastore according to an embodiment. Method 300 begins at step 32, where NFS client 222 mounts NFS share 207 external to the cVol FS container provided by the FS driver for cVol datastore 137. NFS share 207 is not directly accessible by software 224 targeting cVol datastore 137. At step 304, FS provider 218 reparents the top-level NFS objects in NFS share 207 into the file system hierarchy of the cVol FS container for cVol datastore 1737. In embodiments, VM namespaces in NFS share 207 become directories in the file system hierarchy of the cVol FS container. To software 224, it is as if the VM namespaces are physically located in the cVol FS container.

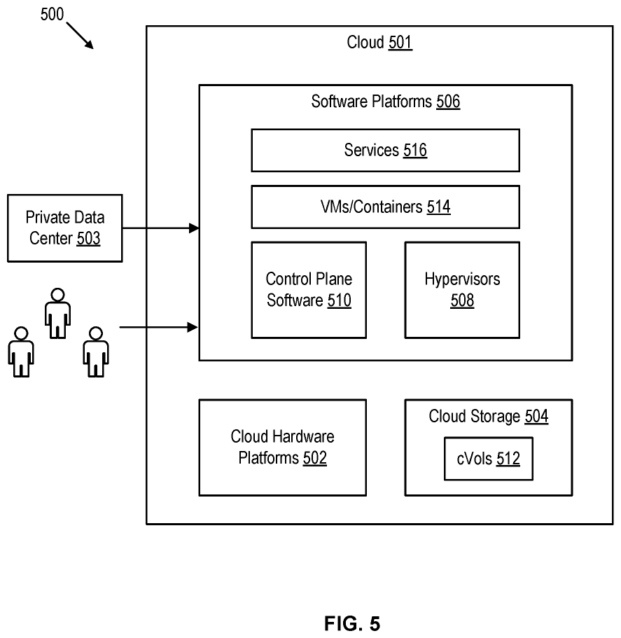

FIG. 4 is a flow diagram depicting a method 400 of accessing VM metadata of a cVol according to an embodiment. Method 400 begins at step 402, where control plane 204 receives an operation targeting VM metadata of a cVol from software 224, At step 404, control plane 204 invokes a system call through FS provider 218 to perform the operation targeting the file system of the cVol FS container of cVol datastore 137. At step 406, control plane 204 routes the operation to the NFS mount for NFS share 207. At step 408, NFS client 222 forwards the operation to FS server 205 targeting NFS share 207.

In addition to the datastore abstraction, cVol must support the object abstraction, which includes of a set of interfaces for object identity and lifecycle management. In embodiments, an object in cVol is identified and located via a uniform resource identifier (URI) in the format of <DS-TYPE>://<CONTAINER-ID>/<PROVIDERID>:<OBJECT-LD>, where DS-TYPE indicates the type of the datastore, CONTAINER-ID identifies the datastore instance, PROVIDER-ID identifies the object storage provider, and OBJECT-ID identifies the object instance within the provider. The UR is stored in a descriptor file in the VM namespace (e.g., virtual disk descriptors 210A/210B). While the details on how objects of a specific object storage provider are supported is out of scope, it is important to note that cVol provides a generic way to manage object storage providers with disparate technologies and implementations, including vSAN and vVol.

In cVol, metadata is stored in NFS share while data is stored separately in objects. The separation of data from metadata enables one to be scaled independently of the other. Compared to traditional NFS datastore, the workload targeting the NFS mount backing such a datastore is metadata centric. The intensity of the metadata workload is directly related to the VM ops. By varying VM ops, we can observe the impact on the NFS share, which can be used to size and scale the NFS server. In addition to the scalability implications, the separation of data from metadata also introduces subtle differences to VM storage availability semantics. A VM on NFS backed object datastore maintains storage availability if and only if it retains access to both the shared NFS namespace and its objects. In contrast, for VMs on regular NFS datastore, VM storage availability is typically that of the NFS datastore itself: for VMs on vSAN and vVol datastores, each has a dedicated VM namespace object, which affects VM storage availability. When the namespace goes down in an NFS backed object datastore, it has a blast radius of all VMs on the datastore. This makes the NFS availability all the more important, just like a regular NFS datastore. While vSAN and vVol have smaller blast radius with the use of dedicated namespace, it may not lead to significant availability improvement in reality due to failure correlation and lack of placement groups,

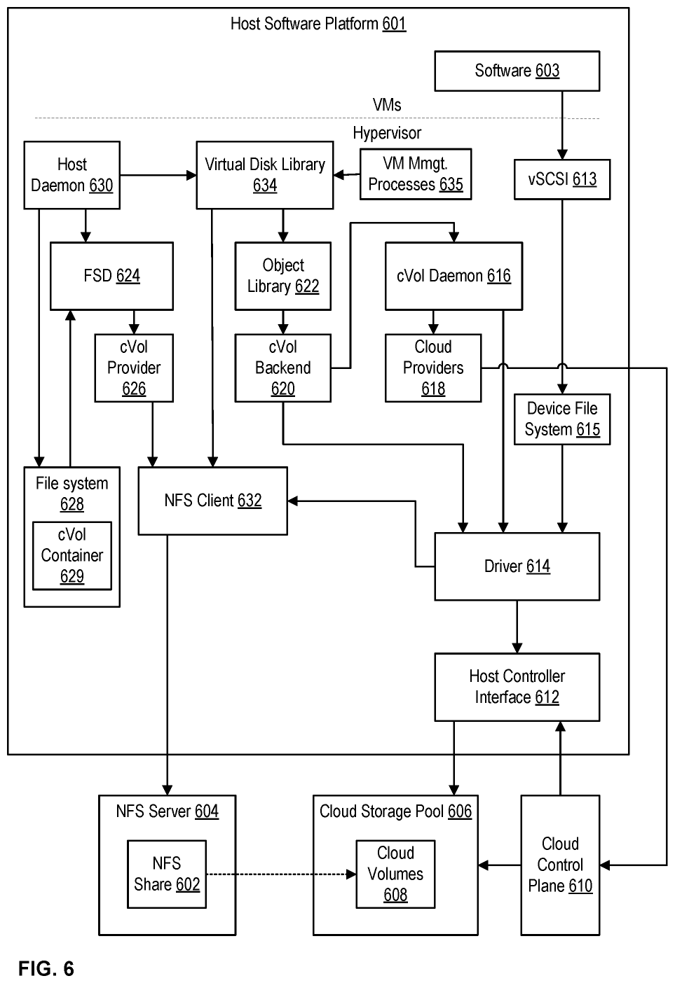

FIG. 5 is a block diagram depicting a cloud computing system 500 according to embodiments. Cloud computing system 500 includes a cloud 501 having cloud hardware platforms 502 and cloud storage 504. Cloud hardware platforms 502 comprises hosts the same or similar to hosts 120 described above. Cloud storage 504 comprises shared storage accessible by cloud hardware platforms 502. Software platforms 506 execute on cloud hardware platforms 502. Software platforms 506 include control plane software 510 and hypervisors 508. Control plane software 510 include virtualization management servers, network managers, and the like. Hypervisors 508 can be configured the same or similar as described above. Users can access software platforms 506 through control plane software 510 to deploy services 516 in VMs and/or containers 514. In some embodiments, cloud computing system 500 can be a hybrid system in which a private data center 503, such as that shown in FIG. 1, can interact with software platforms 506 through control plane software 510 to deploy and manage services 516 in VMs and/or containers 514. In embodiments, software platforms 506 can use cVols 512 in cloud storage 504 as a way for VMs/containers 514 to directly leverage cloud storage 504 as virtual disks. An implementation of cVol architecture 200 in cloud 501 is described below with respect to FIG. 6.

FIG. 6 is a block diagram depicting a cVol architecture implemented in a cloud computing system according to embodiments. Cloud storage 504 includes cloud storage pool 606 and cloud storage control plane 610. Cloud storage control plane 610 exposes APIs to manage cloud volumes 608 within cloud storage pool 606. An NFS server 604 manages an NFS share 602, similar to NFS server 205 and NFS share 207 described above. NFS share 602 stores virtual disk metadata of a cVol 512 in namespaces (e.g., NFS directories) for various VMs. Cloud storage pool 606 can be any type of storage system implemented by cloud 501 and stores cloud volumes 608, provided that cloud volumes 608 are accessible by host software platform 601 as block devices through host controller interface 612 and their lifecycle managed through cloud storage control plane 610. Metadata stored in NFS share 602 references cloud volumes 608 of cVols 512, which store virtual disks for VMs.

Virtual disk metadata of a cVol 512 is accessible through a container in file system 628 (e.g., cVol container 629). In embodiments, cVol container 629 is backed by an NFS share 602. In some cases, a cVol container 629 can be backed by more than one NFS share (not shown). As described above, in embodiments, a mounted NFS share 602 is invisible to the user and not directly accessible as a container in tile system 628. A file system daemon (FSD) 624 is responsible for mounting namespace objects for object datastores into containers in file system 628. FSD 624 includes providers for each type of datastore, including cVol provider 626 for cVols. cVol provider 626 is responsible for managing the mapping between cVol container 629 and NFS share 602 (e.g., by reparenting top level NFS objects, such as files and directories, in cVol container 629), routing file system requests targeting the cVol datastore to NFS server 604, and virtualizing capacity reporting for the cVol datastore. cVol provider 626 interfaces with NFS server 604 to manage NFS share 602 through NFS client 632.

Host daemon 630 is a management process of hypervisor configured to perform various VM workflows Host daemon 630 accesses virtual disk metadata within cVol container 629 through file system 628. While file system 628 is backed by NFS share 602, the latter is shadowed and therefore remains hidden. Host daemon 630 cooperates with FSD 624 to mount a cVol datastore, as described above, through cVol provider 626. Host daemon 630 uses virtual disk library 634 to create, update, delete, and otherwise manage virtual disk metadata, which are stored in the NFS share 602 via NFS client 632 as redirected by file system 628.

A cloud volume 608 is presented as an object to higher-level workflows through an object abstraction. To support the object abstraction, a cVol backend 620 is added to an object library 622, which is responsible for managing objects for the hypervisor. cVol backend 620 is responsible for orchestration of various object workflows, such as create, open, close, and the like, between the hypervisor and cloud control plane 610. cVol backend 620 interfaces with cloud control plane 610 to perform volume-related activities for the workflows through cVol daemon 616 and a respective cloud provider 618. Cloud provider 618 interfaces with an API of cloud control plane 610 and is configured to authenticate with cloud control plane 610. The hypervisor can include multiple cloud providers 618 to support multiple types of cloud control planes for different cloud services. cVol daemon 616 functions as a single control point that manages cloud providers 618, as well as device namespace, device bind, and other system-wide resources.

VM management processes 635 cooperate with virtual disk library 634 to mount virtual disks for access by VMs. Virtual disk library 634 interfaces with object library 622, which invokes cVol backend 620 to interface with cloud control plane 610 to mount virtual disks from cloud volumes 608. VM management processes 635 obtain identifying information for cloud volumes 608 from Virtual disk metadata in cVol container 629 (e.g., descriptor files). A cloud volume 608 can be referred to by a uniform resource indicator (URI) having the format cvol://<CONTATNER-ID>/<PROVIDERID>:<VOLUME-ID>, where the keyword cvol indicates a cVol datastore, CONTAINER-ID identifies a cVol datastore instance, PROVIDER-ID identifies the provider of the volume (e.g., cloud storage pool 606), and VOLUME-ID identifies the volume within the provider (a cloud volume 608).

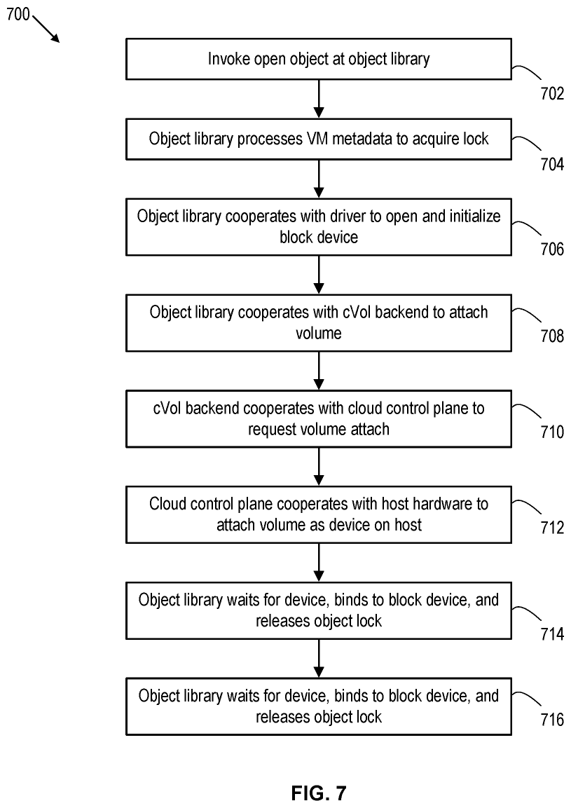

FIG. 7 is a flow diagram depicting a method 700 of opening a virtual disk on a cVol according to an embodiment, Method 700 begins at step 702, where a requester (e.g., host daemon 630) invokes open object at object library 622 (e.g., through virtual disk library 634). At step 704, object library 622 processes virtual disk metadata to acquire a storage lock on the object (e.g., a cloud volume), which results in a storage lock on the virtual disk. The storage lock is an on-disk lock acquired on a companion lock file in NFS share 602. The storage lock is held for as long as the disk is open and is used to prevent incompatible open attempts from another VI At step 706, object library 622 cooperates with driver 614 to open and initialize a block device for the virtual disk. Object library 622 cooperates with driver 614 to open the block device and set a file lock (assuming a lock is obtained at step 704).

At step 707, object library 622 cooperates with driver 614 to acquire a runtime lock and start the bind process. The runtime lock is an in-memory lock used to serialize device bind and is held until the completion of the bind process. The bind process associates ane attached cloud volume with a block device. At step 708, object library 622 cooperates with cVol backend 620 to attach a cloud volume 608 to the host. At step 710, cVol backend 620 cooperates with cloud control plane 610 to request an attach of cloud volume 608. cVol backend 620 invokes API(s) of cloud control plane 610 to attach cloud volume 608 as a device on the host. At step 712, cloud control plane 610 interacts with host hardware to attach cloud volume 608, which is detected by driver 614. At step 714, object library 622 waits for the device, binds the device to the block device, and releases the runtime lock on the virtual disk object (obtained in step 707) At step 716, object library 622 returns a handle to the requestor for the virtual disk object.

Returning to FIG. 6, a cloud volume 608 is presented to its consumers as a virtual block device through a virtual SCSI interface 613 and device file system 615 (e.g., devfs), separate from a physical SCSI device that represents it. Driver 614 manages the lifecycle of the block device, maps it to the underlying SCSI device corresponding to the cloud volume, and provides arbitration on volume access through storage locking. When a virtual disk is opened by a requester (e.g., a VM management process 635 during VM power on), the block device is added to device file system 615 and opened with cloud volume 608 attached. The virtual SCSI device is instantiated with the open file handle to the block device. An IO request initiated by software 603 in a VM targeting the virtual SCSI device is dispatched to the block device through the handle. Driver 614 periodically verifies lock ownership through NFS locking acquired on a companion lock file in the metadata of the VM namespace. Upon successful lock verification, the IO request is sent down to the SCSI extent, which then issues the 10 to the corresponding SCSI device.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of providing a common volume (cVol) datastore for virtual machines (VMs) managed by a hypervisor in a cloud computing system, the method comprising:
mounting, by the hypervisor in cooperation with a network file system server, a network file system share of a common volume (cVol), the network file system share storing metadata for the VMs;
creating a file system container backed by the network file system (NFS) share;
routing file operations targeting the metadata to the file system container;
attaching cloud volumes as devices on a host of the hypervisor, the cloud volumes referenced by descriptors in the metadata; and
routing file operations targeting virtual disks of the VMs to the devices.

2. The method of claim 1, wherein the network file system share is mounted external to the file system container, and wherein directories of the NFS share are reparented in the file system container.

3. The method of claim 2, wherein each of the directories stores a portion of the metadata for a namespace of a respective one of the VMs.

4. The method of claim 3, wherein each of the directories stores one or more descriptors pointing to one or more of the cloud volumes backing one or more of the virtual disks.

5. The method of claim 4, wherein the file operations targeting the virtual disks are routed to the devices by a data plane of the hypervisor.

6. The method of claim 5, wherein the file operations targeting the metadata are routed to the file system container by a control plane of the hypervisor.

7. The method of claim 1, wherein the step of attaching comprises:
invoking, by the hypervisor, an application programming interface (API) of a cloud control plane configured to manage a cloud storage pool having the cloud volumes, the API configured to cooperate with hardware of the host to attach the cloud volumes as the devices.

8. A non-transitory computer readable medium comprising instructions to be executed in a computing device to cause the computing device to carry out a method of providing a common volume (cVol) datastore for virtual machines (VMs) managed by a hypervisor in a cloud computing system, the method comprising:
mounting, by the hypervisor in cooperation with a network file system server, a network file system share of a common volume (cVol), the network file system share storing metadata for the VMs;
creating a file system container backed by the network file system (NFS) share;
routing file operations targeting the metadata to the file system container;
attaching cloud volumes as devices on a host of the hypervisor, the cloud volumes referenced by descriptors in the metadata; and
routing file operations targeting virtual disks of the VMs to the devices.

9. The non-transitory computer readable medium of claim 8, wherein the network file system share is mounted external to the file system container, and wherein directories of the NFS share are reparented in the file system container.

10. The non-transitory computer readable medium of claim 9, wherein each of the directories stores a portion of the metadata for a namespace of a respective one of the VMs.

11. The non-transitory computer readable medium of claim 10, wherein each of the directories stores one or more descriptors pointing to one or more of the cloud volumes backing one or more of the virtual disks.

12. The non-transitory computer readable medium of claim 11, wherein the file operations targeting the virtual disks are routed to the devices by a data plane of the hypervisor.

13. The non-transitory computer readable medium of claim 12, wherein the file operations targeting the metadata are routed to the file system container by a control plane of the hypervisor.

14. The non-transitory computer readable medium of claim 8, wherein the step of attaching comprises:
invoking, by the hypervisor, an application programming interface (API) of a cloud control plane configured to manage a cloud storage pool having the cloud volumes, the API configured to cooperate with hardware of the host to attach the cloud volumes as the devices.

15. A cloud computing system, comprising:
a host having a hardware platform; and
a hypervisor executing on the hardware platform supporting virtual machines (VMs), the hypervisor configured to provide a common volume (cVol) datastore for the VMs by:
mounting, by the hypervisor in cooperation with a network file system server, a network file system share of the cVol, the network file system (NFS) share storing metadata for the VMs;
creating a file system container backed by the network file system share;
routing file operations targeting the metadata to the file system container;
attaching cloud volumes as devices on a host of the hypervisor, the cloud volumes referenced by descriptors in the metadata; and
routing file operations targeting virtual disks of the VMs to the devices.

16. The cloud computing system of claim 15, wherein the network file system share is mounted external to the file system container, and wherein directories of the NFS share are reparented in the file system container.

17. The cloud computing system of claim 16, wherein each of the directories stores a portion of the metadata for a namespace of a respective one of the VMs.

18. The cloud computing system of claim 17, wherein each of the directories stores one or more descriptors pointing to one or more of the cloud volumes backing one or more of the virtual disks.

19. The cloud computing system of claim 15, wherein the file operations targeting the virtual disks are routed to the devices by a data plane of the hypervisor.

20. The cloud computing system of claim 19, wherein the file operations targeting the metadata are routed to the file system container by a control plane of the hypervisor.
